(19) United States
(12) Patent Application Publication
(10) Pub. No.: US 2019/0216089 A1
(43) Pub. Date: Jul. 18, 2019

(54) COMPOUNDED HERBICIDAL COMPOSITION CONTAINING SHUANGZUOCAOTONG AND METHOD OF USING THE SAME

(71) Applicant: QINGDAO KINGAGROOT RESISTANT WEED MANAGEMENT CO., LTD., QINGDAO SHANDONG (CN)

(72) Inventors: XUEGANG PENG, QINGDAO SHANDONG (CN); TAO JIN, QINGDAO SHANDONG (CN); JINGYUAN ZHANG, QINGDAO SHANDONG (CN)

(21) Appl. No.: 16/312,770

(22) PCT Filed: May 18, 2017
(86) PCT No.: PCT/CN2017/084916

§ 371 Date: Dec. 21, 2018

(30) Foreign Application Priority Data
Jun. 21, 2016 (CN) 201610452583.0

(51) Int. Cl. A01N 57/20; A01N 43/56

(52) U.S. Cl. CPC A01N 57/20; A01N 43/56

(57) ABSTRACT

The present invention relates to a compounded herbicidal composition containing Shuangzuocaotong and a method of using the same. The compounded herbicidal composition comprises an active ingredient A and an active ingredient B, wherein the active ingredient A is Shuangzuocaotong, and the active ingredient B is glyphosate or glufosinate ammonium, and the two active ingredients are present in a weight ratio of 1:100-1, preferably 1:60-1. The compounded herbicidal composition has synergistic effect and excellent activity to control resistant weeds.

### TECHNICAL FIELD

The present invention relates to a compounded herbicidal composition containing shuangzuocaotong and a method of using the same, and belongs to the technical field of pesticides.

### BACKGROUND ART

Glyphosate is a herbicide having a molecular formula of C₃H₈NO₅P and a chemical name of N-(phosphonomethyl)glycine, which was developed by Monsanto Company, U.S. Glyphosate is a broad-spectrum, systemic-translocation and non-selective post-emergence herbicide having high efficacy and low toxicity, and may be applied by spraying on foliar surfaces. Glyphosate mainly act by inhibiting the enolpyruvylshikimate phosphate synthase in plants, thus inhibiting the conversion of sikimin to phenylalanine, tyrosine and tryptophan, disturbing the synthesis of proteins, and causing the death of the plants. Glyphosate is absorbed into plants through foliage and translocated to whole tissues of the plants, inhibiting the biosynthesis of amino acids, interfering with photosynthesis and killing the plants. Glyphosate controls more than 40 families of plants including monocotyledonous plants and dicotyledonous plants, annual plants and perennial plants, herbaceous plants and shrub plants. Glyphosate quickly combines with metal ions such as iron and aluminum ions after enters into the soil to lose its activity, and has no adverse effects on the seeds or soil microbes in the soil.

Glufosinate ammonium is a herbicide having a molecular formula of C₅H₁₅N₂O₄P and a chemical name of ammonium-DL-homoalanin-4-yl(methyl)phosphinate, which was developed by Hoechst in the 1980s and is a broad-spectrum, contact herbicide. Glufosinate ammonium does not have a strong systemic effect, and is used in orchards, vineyards, non-cultivated lands, potato fields, etc. to control annual and perennial dicotyledonous and Gramineae weeds. Glutamine synthetase plays an important role in the nitrogen metabolism in plants and is an important detoxifying enzyme in plants, which can relieve the toxicity of ammonia released by nitrate reduction, amino acid degradation and photorespiration. A target enzyme of glufosinate ammonium is glutamine synthetase (GS). Glufosinate ammonium inhibits the activity of GS in plants, causing dysregulation of nitrogen metabolism and deficiency of essential amino acids in plants, and eventually leading to excessive ammonia in cells, whereby the cells are poisoned, then chlorophyll breakdown, and the plants die. Compared with glyphosate, glufosinate ammonium has special effect against noxious weeds such as Capsella bursa-pastoris and Conyza Canadensis, but glyphosate is ineffective against these noxious weeds.

Hydroxyphenylpyruvate dioxygenase (HPPD) is a new target of herbicides identified in the 1990s. The HPPD-targeted inhibitors have a broad-spectrum herbicidal activity and can control broadleaf weeds in broadleaf crops. The inhibitors can be used during both pre-emergence and post-emergence, and are characterized by having high activity, low residues, good environmental compatibility and safe application. The HPPD-targeted inhibitors are developed late, and the development of weed's resistance to this kind of inhibitor is slower than to the herbicides having other mechanisms of action. In addition, there is no cross-resistance between the HPPD-targeted inhibitors with commonly-used herbicides having other mechanisms of action. Therefore, the HPPD-targeted inhibitors can be used as an important solution for the management of resistant weeds.

### SUMMARY

The present invention provides a compounded herbicidal composition containing Shuangzuocaotong and a method of using the same. The compounded herbicidal composition of Shuangzuocaotong with glyphosate or with glufosinate ammonium brings about synergistic effect and has excellent activity to control resistant weeds.

The technical solution of the present invention is:

a Shuangzuocaotong-containing compounded herbicidal composition comprising active ingredients A and B, said active ingredient A being shuangzuocaotong of

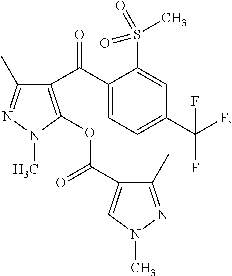 [SMILES: Cc1nn(C)cc1C(=O)Oc1c(C(=O)c2ccc(C(F)(F)F)cc2S(C)(=O)=O)c(C)nn1C]

and the active ingredient B being glyphosate or glufosinate ammonium.

The active ingredient A and the active ingredient B may be present in a weight ratio of 1:100-1, preferably 1:60-1.

The active ingredients A and B in the compounded herbicidal formulation of the invention usually may have a concentration from 0.001% to 98% by weight, preferably from 0.01% to 90% by weight. In a formulation designed for use as a concentrate, the active ingredients are usually present in a concentration of from 5% to 98% by weight, preferably from 10% to 90% by weight, more preferably from 20% to 75% by weight.

The compounded herbicidal composition may be mixed with at least one auxiliary that is commonly used in a formulation technology to obtain a compounded herbicidal formulation.

The auxiliaries commonly used in formulation technologies include liquid carriers, solid carriers, dispersing agents, emulsifying agents, stabilizing agents, antifreezing agents, thickening agents and other well-known substances which are useful for the active ingredients to be stable or exert their effect in the formulation. Preferable auxiliaries are those commonly used or allowed to be used in pesticides. Particular ingredients and dosages are determined by simple tests according to the formulation requirements.

Liquid carrier suitable for preparing the compounded herbicidal formulations of the invention is preferably an aromatic hydrocarbon or an aliphatic hydrocarbon, particularly preferably a polar solvent, such as alcohols and ethers or esters thereof. In addition, vegetable oil can be selected. Meanwhile, a mixture of different liquids is also applicable.

Solid carrier suitable for preparing the compounded herbicidal formulations of the present invention is preferably one or more selected from the group consisting of diatomite, aluminum magnesium silicate, activated clay, kaolin, clay, gypsum, bentonite, white carbon black, light calcium carbonate, lime stone, saw dust, corn starch and soluble starches.

Dispersing agent suitable for preparing the compound herbicidal formulations of the present invention is preferably one or more selected from the group consisting of alkylnaphthalene sulfonate, bis(alkyl)naphthalene sulfonate-formaldehyde condensate, naphthalene sulfonate formaldehyde condensate, alkylphenol polyoxyethylene phosphate, alkylphenol polyoxyethylene ether formaldehyde condensate sulfate, alkylphenol polyoxyethylene ether phosphate, alkylphenol polyoxyethylene ether, castor oil ethylene oxide adduct, ethylene oxide-propylene oxide block copolymers, alkylphenol polyoxyethylene ether formaldehyde condensates, octylphenol polyoxyethylene ether sulfate and methyl cellulose. For example, sodium lignosulfonate, calcium lignosulfonate, sodium methyl naphthalenesulfonate formaldehyde condensate, sodium naphthalenesulfonate formaldehyde condensate and sodium methylene naphthalenesulfonate.

The emulsifying agents suitable for preparing the compounded herbicidal formulations of the present invention is preferably selected from anionic and/or nonionic emulsifiers, such as one or more selected from the group consisting of alkylphenol polyoxyethylene ether, alkylphenol polyoxyethylene polyoxypropylene ether, benzylphenol polyoxyethylene ether, polyoxyethylene fatty acid ester, polyoxyethylene fatty alcohol ether, polyoxyethylene fatty amine and alkylphenol polyglycol ether.

Carboxymethyl cellulose, ethylene glycol, propylene glycol, etc., which are commonly used as auxiliaries in herbicidal formulations may also be added.

The compounded herbicidal composition and an auxiliary that is normally used in formulation technology can be formulated into any agriculturally acceptable dosage forms. The preferred dosage forms of the present invention include liquids, wettable powders, soluble powders, soluble granules, emulsifiable concentrates, water suspensions, dispersible oil-based suspensions, microcapsules, microemulsions, aqueous emulsions, suspension emulsions, water dispersible granules, microencapsulated water suspension concentrates (ZC), ultra-low volume liquids, and seed coatings.

For suspensions, the auxiliaries which can be used include: dispersing agents, emulsifying agents, wetting agents, thickening agents, preservatives, antifoaming agents, and antifreezing agents; wherein the dispersing agent may be selected from the group consisting of polycarboxylate, lignosulfonate and alkylnaphthalene sulfonate; the emulsifying agent may be selected from the group consisting of Pesticide Emulsifier 700# (generic name: alkylphenol formaldehyde resin polyoxyethylene ether), Pesticide Emulsifier 2201, SPAN® 60# (generic name: sorbitan monostearate), Emulsifier TWEEN® 60# (generic name: polyoxyethylene sorbitan monostearate), Pesticide Emulsifier 1601# (generic name: phenylethylphenol polyoxyethylene polyoxypropylene ether); the wetting agent may be selected from the group consisting of alkylphenol polyoxyethylene ether formaldehyde condensate sulfate, alkylphenol polyoxyethylene ether phosphate, phenylethylphenol polyoxyethylene ether phosphates, alkyl sulfates, alkyl sulfonates, naphthalenesulfonate and TERSPERSE® 2500 (manufactured by Huntsman Corporation, U.S.); the thickening agent may be selected from the group consisting of xanthan gum, polyvinyl alcohol, bentonite and aluminum magnesium silicate; the preservative may be selected from the group consisting of formaldehyde, benzoic acid and sodium benzoate; the antifoaming agent may be an organic silicon antifoaming agent; and the anti-freezing agent may be selected from the group consisting of ethylene glycol, propylene glycol, glycerol, urea and inorganic salts (such as sodium chloride).

For dispersible oil-based suspensions, the auxiliaries which can be used include: dispersing agents, emulsifying agents, wetting agents, thickening agents, antifreezing agents, stabilizing agents and dispersion media; wherein the dispersing agent may be selected from the group consisting of polycarboxylate, lignosulfonate, alkyl naphthalenesulfonate (Dispersant NNO) and TERSPERSE®2425; the emulsifying agent may be selected from the group consisting of emulsifier BY (castor oil polyoxyethylene ether) series (BY-110, BY-125, BY-140), Pesticide Emulsifier 700#(generic name: alkylphenol formaldehyde resin polyoxyethylene ether), Pesticide Emulsifier 2201, SPAN® 60# (generic name: sorbitan monostearate), TWEEN® 60#(generic name: polyethylene glycol sorbitan monostearate), Pesticide Emulsifier 1601# (generic name: phenethylphenol polyoxyethylene polyoxypropylene ether) and TERSPERSE® 4894; the wetting agent may be selected from the group consisting of alkylphenol polyoxyethylene ether formaldehyde condensate sulfates, alkylphenol polyoxyethylene ether phosphate, phenylethylphenol polyoxyethylene ether phosphate, alkyl sulfate, alkyl sulfonate, naphthalenesulfonate and TERSPERSE® 2500; the thickening agent may be selected from the group consisting of white carbon black, polyvinyl alcohol, bentonite and aluminum magnesium silicate; the anti-freezing agent may be selected from the group consisting of ethylene glycol, propylene glycol, glycerol, urea and inorganic salts (such as sodium chloride); and the stabilizing agent may be selected from the group consisting of epoxidized soybean oil, epichlorohydrin, triphenyl phosphate; the dispersion media may be selected from the group consisting of soybean oil, rapeseed oil, corn oil, methyl oleate, diesel oil, machine oil and mineral oil.

For wettable powders, the auxiliaries which can be used include: dispersing agents, wetting agents and solid carriers; wherein dispersing agent may be selected from the group consisting of polycarboxylate, lignosulfonates and alkyl naphthalenesulfonate; the wetting agent may be selected from the group consisting of alkyl sulfate, alkyl sulfonate and naphthalenesulfonate; and the solid carrier may be selected from the group consisting of ammonium sulfate, urea, sucrose, glucose, diatomite, kaolin, white carbon black, light calcium carbonate, talc, attapulgite and pottery clay.

For water dispersible granules, the auxiliaries which can be used include: dispersing agents, wetting agents, disintegrants, binders and solid carriers; wherein the dispersing agent may be selected from the group consisting of polycarboxylate, lignosulfonate, alkylnaphthalene sulphonate, alkylphenol polyoxyethylene ether and EO/PO block polyether; the wetting agent may be selected from the group consisting of alkyl sulfate, alkyl sulfonate, naphthalene sulfonate, sodium lignosulfonate, fatty alcohol polyoxyethylene ether and alkylphenol polyoxyethylene ether; the disintegrant may be selected from the group consisting of ammonium sulfate, sodium sulfate, sodium chloride, ammonium chloride, urea, sucrose, glucose, carboxymethyl cellulose, soluble starch and polyvinylpyrrolidone; the binder may be selected from the group consisting of polyvinyl alcohol, soluble starch, dextrin, xanthan gum and carboxymethyl(ethyl) cellulose; and the solid carrier may be selected from the group consisting of diatomite, kaolin, white carbon black, light calcium carbonate, talc, attapulgite and pottery clay.

The present invention further provides a method for controlling an undesired plant comprising applying the compounded herbicidal composition to a growing place and/or foliage of the undesired plant.

The undesired plant may be a Gramineae weed, broadleaf weed or Cyperaceae weed, for example, the undesired plant is selected from a group consisting of Stellaria, Nasturtium, Agrostis, Digitaria, Avena, Setaria, Sinapis, Lolium, Solanum, Bromus, Alopecurus, Matricaria, Abutilon, Sida, Xanthium, Amaranthus, Chenopodium, Ipomoea, Chrysanthemum, Galium, Viola L and Veronica; specifically, for example, such as, Scirpus planiculmis Fr. Schmidt, Eleocharis yokoscensis (franch. et savat) tang et wang, Japanese Scirpus trigueter L., Juncellus serotinus, Cyperus iria L., Cyperus difformis L.; Descurainia Sophia, Digitaria sanguinalis (l.) scop., Capsella bursa-pastoris, Semen Euphorbiae, Herba Setariae Viricis, Poa annua L., Eleocharis yokoscensis (franch. et savat.) tang et wang, Scirpus juncoides Roxb, Monochoria vaginalis (burm. f.) presl ex kunth, Rotala indica (Willd.) Koehne, Callitriche stagnalis Scop., Ottelia alismoides (L) Pers., Scirpus yagara ohwi, Sagittaria trifolia L., Potamogeton distinctus a. benn., galium aparine l. var. tenerum (gren. et godr.) rchb., Cirsium setosum (willd.) mb, Xanthium sibiricum patr. ex wider, Cyperus rotundus L., Acalypha australis l., Chenopodium album l., Amaranthus spinosus L. and Amaranthus retroflexus L., Thlaspi caerulensens, Thalictrum apuilegifolium l. var. sibiricum regel er tiling, Portulaca oleracea l. and so on.

The active ingredients of the invention may also be applied in combination with one or more other herbicides to control a wider range of undesired vegetation. When used in combination with other herbicides, the active ingredients can be formulated with other herbicides or applied with other herbicides sequentially. The synergistic effect can be achieved by compounding the active ingredients of the present invention with one or more herbicides described below.

Herbicides which can be used in combination with the active ingredients of the present invention include: 2,4-D, acetochlor, acifluorfen, aclonifen, alachlor, amidosulfuron, aminopyralid, aminotriazole, ammonium thiocyanate, azimsulfuron, benfuresate, bensulfuron-methyl, bentazone, benthiocarb, benzobicyclon, benzofenap, bifenox, bispyribac-sodium, bromacil, bromobutide, bromoxynil, butralin, cafenstrole, carbetamide, carfentrazone-ethyl, chlorflurenol, chlorimuron, chlorpropham, cinosulfuron, clethodim, clodinafop-propargyl, clomazone, clomeprop, clopyralid, cloransulam-methyl, cumyluron, cyclosulfamuron, cycloxydim, cyhalofop-butyl, daimuron, dicamba, dichlobenil, dichlorprop-p, diclosulam, diflufenican, diflufenzopyr, dimepiperate, dimethametryn, dimethenamid, dimethenamid-p, diquat, dithiopyr, diuron, esprocarb, ethoxysulfuron, etobenzanid, fenoxaprop, fenoxaprop-ethyl, fentrazamide, flazasulfuron, florasulam, fluazifop, fluazifop-p-butyl, flucetosulfuron, flufenacet, flufenpyr-ethyl, flumetsulam, flumiclorac-pentyl, flumioxazin, fluometuron, flupyrsulfuron fluroxypyr, fomesafen, foramsulfuron, fumiclorac, glyphosate, halosulfuron, haloxyfop-methyl, haloxyfop-R, imazamethabenz, imazamox, imazapic, imazapyr, imazaquin, imazethapyr, flazasulfuron, indanofan, iodosulfuron, ioxynil, isoproturon, isoxaben, isoxaflutole, lactofen, MCPA, MCPB, mecoprop-p, mefenacet, mesosulfuron, mesotrione, metamifop, metolachlor, metosulam metsulfuron, molinate, monosulfuron, MSMA, napropamide, nicosulfuron, norflurazon, OK-9701, orthosulfamuron, oryzalin, oxadiargyl, oxadiazon, oxyfluorfen, paraquat, pendimethalin, pentoxazone, pethoxamid, picloram, picolinafen, piperophos, pretilachlor primisulfuron, profoxydim, propachlor, propanil, propisochlor, propyzamide, prosulfocarb, prosulfuron, pyraclonil, pyraflufen-ethyl pyrazogyl, pyrazolynate, pyrazosulfuron-ethyl, pyrazoxyfen, pyribenzoxim, pyrabuticarb, pyriftalid, pyriminobac-methyl, pyroxsulam, quinclorac, quinoclamine, quizalofop-ethyl-D, saflufenacil, sethoxydim, simazine, simetryne, S-metolachlor, sulcotrione, sulfentrazone sulphosate, tefuryltrione, tembotrione, terbacil, thenylchlor, thiazopyr, thiobencarb, triclopyr, trifluralin, trinexapac-ethyl and tritosulfuron.

Compared with the prior art, the present invention has the following beneficial effects:

(1) In the present invention, a combination of glyphosate or glufosinate ammonium and Shuangzuocaotong has good activity to control weeds in the fields, effectively reducing hazard of weeds to field crops, increasing crop yield, and improving the quality.

(2) A combination of glyphosate or glufosinate ammonium and Shuangzuocaotong brings about certain complementarity and synergy to the herbicidal spectrum, and the combination can reduce the amount of each component, reducing the phytotoxicity, reducing residual activity, and delaying the occurrence and development of resistance to herbicides.

### SPECIFIC MODE FOR CARRYING OUT THE INVENTION

The present invention is further described below in conjunction with the application examples.

### Application Example 1

Experimental report on determination of herbicidal activity of a combination of glufosinate ammonium or glyphosate with Shuangzuocaotong

1 Experimental conditions

1.1 Tested Targets

Descurainia Sophia and Capsella bursa-pastoris were collected from wheat fields in Huangdao Experimental Base of Shandong Province in 2015.

The above weeds were cultivated by a pot culture method. A 180×140 mm plastic nutritional bowl contained 4/5 topsoil from the field was placed in an enamel pan, wherein the soil had been air-dried and screened and had an initial moisture content of 20%. Full and uniform weed seeds were selected, soaked in warm water at 25° C. for 6 hours, and germinated in a 28° C. biochemical incubator (darkness). The weed seeds that had just germinated were evenly placed on the surface of the soil and then covered with 0.7 cm soil, and cultured in a controllable sunlight greenhouse after being treated with agents. A certain amount of water was added to the enamel pan regularly to keep the soil moist.

1.2 Culture Conditions

The culture was carried out in a controllable sunlight greenhouse at 18 to 30° C., in natural light, and relative humidity of 57% to 72%.

The soil was loam with an organic matter content of 1.63%, a pH value of 7.1, an alkali-hydrolyzable nitrogen of 84.3 mg/kg, a rapidly available phosphorus of 38.5 mg/kg, and a rapidly available potassium 82.1 mg/kg.

1.3 Equipments and Apparatuses

3WP-2000-type Walking Spray Tower (Nanjing Institute of Agricultural Machinery, the Ministry of Agriculture); GA110-type ten thousandth Electronic Balance (Germany); ZDR2000-type Intelligent Data Recorder (Hangzhou Zeda Instrument Co., Ltd.); and SPX-type Intelligent Biochemical Incubator (Ningbo Jiangnan Instrument Factory).

2 Designs of Experiments

2.1 Reagents

2.1.1 Agents for the experiments

95% glyphosate, technical material (TC) (provided by Zhejiang Wynca Chemical Industry Group Co., Ltd.);

95% glufosinate ammonium, TC (provided by Zhejiang Yongnong Biological Science Co., Ltd.)

95% Shuangzuocaotong, TC (provided by Qingdao Nongguan Pesticide Co., Ltd.).

Since these several agents were soluble in acetone, any two TCs were dissolved in acetone, and diluted with an aqueous solution containing 0.1% emulsifier T-80. The dilution was performed as required.

2.2 Experimental Treatments

2.2.1 Determination of Dose

A ratio of glufosinate ammonium or glyphosate and shuangzuocaotong and amounts thereof in each group depends on the characteristics and toxicity of the two agents, as well as the main application purpose of a corresponding formulation. Glyphosate is a non-selective herbicide and is absorbed by foliage and translocated to various parts of the plant, which is different from the mechanism of action of glufosinate ammonium, i.e., killing roots. Glufosinate ammonium is a contact herbicide having weak systemic effect and not being translocated, and it only produces drug spots at the contact sites and has a fast action. Shuangzuocaotong has a broad-spectrum herbicidal activity and can control broadleaf weeds, and it is mainly applied during post-emergence and is characterized by having high activity, low residues, good environmental compatibility and safe application. The control spectrum of Shuangzuocaotong is complementary to that of glyphosate or that of glufosinate ammonium to some extent. The combination of glufosinate ammonium or glyphosate with Shuangzuocaotong was conducive to reduce the amount of each component and reduce environmental pollution. Based on the pre-tests in this study, the doses of glyphosate, glufosinate ammonium, and Shuangzuocaotong applied alone and in combination were shown in the Table 1 and Table 2, and a total 15 groups were designed, respectively. Water containing the solvent and emulsifying agent same with the above groups but free of the agents was used as a blank control.

2.2.2 Repetition of Experiments

3 pots with 20 weed seeds per pot were treated in one treatment with 4 replications per treatment, that is, a total of 60 weeds were treated in one treatment.

2.3 Treatment Method

2.3.1 the Timing and Frequency of the Treatment

The agents were used for only once in the experiment. In the stage of weeds with 2 leaves and 1 core, the weeds were thinned out to maintain 15 weeds per pot and 45 weeds for each treatment, then continued to be cultured until the four true leaves of Descurainia sophia and Capsella bursa-pastoris emerged, and treated.

2.3.2 Equipments and Methods for Applying Agents

The well-cultured weeds were evenly placed on a platform with an area of 0.5 m², and a solution of agents was sprayed on the foliage thereof by the 3WP-2000-type walking spray tower at a dosage of 30 kg/ha and at a spray pressure of 0.3 MPa. After all the solution was sprayed, the valve was closed. After 30 seconds, the door of the spray tower was opened, and the nutritional bowl was taken out. Then the valve was opened, and the spray tube was cleaned by spraying 50 ml of water.

3 Experimental Methods

A pot-culture method was employed. For the cultivation of weeds, please refer to the Section 1.1, and “Pesticide guidelines for laboratory bioactivity tests—herbicides”. As to a method for applying agents, please refer to the section 2.3.2, that is, a method for foliage treatment was employed.

4 Data Investigation and Statistical Analysis

4.1 Investigation Methods

A method for investigating absolute number was employed, wherein whole seedlings of survival weeds were cut off with a blade along the soil surface, and the fresh weight of the weeds was weighed with an analytical balance. For dead weeds, the fresh weight thereof was zero.

4.2 Investigation Timing and Frequency

The investigation was performed after 20 days of the treatment for only once.

4.3 Statistical Analysis of the Data

Theoretical fresh weight inhibition rate of a combination of two active ingredients in each group was calculated by the Gowing method (E0=X+Y−X*Y/100), and then compared with an actually measured inhibition rate (E), thereby effect of the combination (hereafter referred to as combined effect) on weeds was evaluated: the value of E−E0, which was greater than 10%, corresponded to a synergistic effect, the value of E−E0, which was less than −10%, corresponded to an antagonistic effect, and the value of E−E0, which was from −10% to 10%, corresponded to an additive effect. An optimum ratio of the two active ingredients was determined by the actual control effect, characteristics of herbicides, and balance of a corresponding formula.

Wherein, in the formula, X represented the fresh weight inhibition rate of glufosinate ammonium or glyphosate in a dosage of P, and Y represented the fresh weight inhibition rate of Shuangzuocaotong in a dosage of Q. The statistical results were shown in the Table 1 and Table 2.

5. Analysis and Discussion of Results

5.1 Potency Evaluation

Combinations of the agents: the experimental results (Table 1, Table 2) showed that a combination of glyphosate or glufosinate ammonium with Shuangzuocaotong had an inhibition rate of E−E0 value≥0 for the two weeds, exhibiting a certain trend of additive or synergistic effect.

A dosage form of a formulation to be processed should be appropriately considered to selected ratio and content ranges of agents in the formulation. If the formulation was processed into a dispersible oil-based suspension, the total content of the agents should not be too high, otherwise the formulation was too viscous to be processed, and in this case, a relatively small ratio was generally selected. If the two agents were processed into a wettable powder, water dispersible granule or aqueous suspension, the ratio could be broader.

TABLE 1
Combined effect of a combination of glyphosate and shuangzuocaotong on weeds (Gowing method)

| | | Descurainia sophia | | | Capsella bursa-pastoris | | |
|---|---|---|---|---|---|---|---|
| | dose | actual | theoretical | | actual | theoretical | |
| | of active | fresh weight | fresh weight | | fresh weight | fresh weight | |
| | ingredient | inhibition rate | inhibition rate | | inhibition rate | inhibition rate | |
| Agents | (g/hm²) | (%) | (%) | E − E0 | (%) | (%) | E − E0 |
| glyphosate | 675 | 55.2 | — | — | 53.2 | — | — |
| | 900 | 73.1 | — | — | 74.6 | — | — |
| | 1125 | 91.4 | — | — | 92.4 | — | — |
| Shuangzuocaotong | 15 | 54.2 | — | — | 53.2 | — | — |
| | 30 | 76.2 | — | — | 75.2 | — | — |
| | 45 | 90.2 | — | — | 91.3 | — | — |
| glyphosate + | 675 + 15 | 100 | 79.5 | 20.5 | 100 | 78.1 | 21.9 |
| Shuangzuocaotong | 675 + 30 | 100 | 89.3 | 10.7 | 100 | 88.4 | 11.6 |
| | 675 + 45 | 100 | 95.6 | 4.4 | 100 | 95.9 | 4.1 |
| | 900 + 15 | 100 | 87.7 | 12.3 | 100 | 88.1 | 11.9 |
| | 900 + 30 | 100 | 93.6 | 6.4 | 100 | 93.7 | 6.3 |
| | 900 + 45 | 100 | 97.4 | 2.6 | 100 | 97.8 | 2.2 |
| | 1125 + 15 | 100 | 96.1 | 3.9 | 100 | 96.4 | 3.6 |
| | 1125 + 30 | 100 | 98.0 | 2.0 | 100 | 98.1 | 1.9 |
| | 1125 + 45 | 100 | 99.2 | 0.8 | 100 | 99.3 | 0.7 |

Evaluation of herbicidal effect: the result of the evaluation of the herbicidal effect of glyphosate combined with Shuangzuocaotong against Descurainia Sophia and Capsella bursa-pastoris was shown in Table 1. It could be seen that a combination of glyphosate and Shuangzuocaotong in a mixed ratio of 675+15, 675+30 or 900+15 had synergistic effect against Descurainia Sophia, wherein the E−E0 value corresponded to 20.5, 10.7, or 12.3, respectively; a combination of glyphosate and Shuangzuocaotong in a mixed ratio of 675+15, 675+30, or 900+15 also showed synergistic effect against Capsella bursa-pastoris, wherein the E−E0 values corresponded to 21.9, 11.6, or 11.9, respectively. Among them, the synergistic effect of the combination in the mixed ratio of 675+15 against Descurainia Sophia and Capsella bursa-pastoris was the most obvious, and the E−E0 values were 20.5 and 21.9, respectively. It could be seen that a combination of glyphosate at a low dose and Shuangzuocaotong at a low dose showed a very good synergistic effect, while a combination of the both at the highest dose for each showed an additive effect. A combination of glyphosate and Shuangzuocaotong could achieve good control effect at a reduced dose. The synergistic effect of a combination of Shuangzuocaotong and glyphosate at a ratio of about 1:20-60 was more significant.

TABLE 2
Combined effect of a combination of glufosinate ammonium and shuangzuocaotong on weeds (Gowing method)

| | | Descurainia sophia | | | Capsella bursa-pastoris | | |
|---|---|---|---|---|---|---|---|
| | dose | actual | theoretical | | actual | theoretical | |
| | of active | fresh weight | fresh weight | | fresh weight | fresh weight | |
| | ingredient | inhibition rate | inhibition rate | | inhibition rate | inhibition rate | |
| Agents | (g/hm²) | (%) | (%) | E − E0 | (%) | (%) | E − E0 |
| Glufosinate | 300 | 49.8 | — | — | 48.2 | — | — |
| ammonium | 450 | 71.6 | — | — | 73.2 | — | — |
| | 600 | 92.6 | — | — | 93.5 | — | — |
| Shuangzuocaotong | 67.5 | 53.3 | — | — | 54.1 | — | — |
| | 90 | 74.3 | — | — | 72.4 | — | — |
| | 112.5 | 86.2 | — | — | 93.5 | — | — |
| glufosinate | 300 + 15 | 100 | 76.6 | 23.4 | 100 | 76.2 | 23.8 |
| ammonium + | 300 + 30 | 100 | 87.1 | 12.9 | 100 | 85.7 | 14.3 |
| Shuangzuocaotong | 300 + 45 | 100 | 93.1 | 6.9 | 100 | 96.6 | 3.4 |
| | 450 + 15 | 100 | 86.7 | 13.3 | 100 | 87.7 | 12.3 |
| | 450 + 30 | 100 | 92.7 | 7.3 | 100 | 92.6 | 7.4 |
| | 450 + 45 | 100 | 96.1 | 3.9 | 100 | 98.3 | 1.7 |
| | 600 + 15 | 100 | 96.5 | 3.5 | 100 | 97.0 | 3.0 |
| | 600 + 30 | 100 | 98.1 | 1.9 | 100 | 98.2 | 1.8 |
| | 600 + 45 | 100 | 99.0 | 1.0 | 100 | 99.6 | 0.4 |

Evaluation of herbicidal effect: the result of the evaluation of the herbicidal effect of glufosinate ammonium combined with Shuangzuocaotong against Descurainia Sophia and Capsella bursa-pastoris were shown in Table 2. It could be seen that a combination of glufosinate ammonium and Shuangzuocaotong in a mixed ratio of 300+15, 300+30 or 450+15 had synergistic effect against Descurainia Sophia, wherein the E−E0 value corresponded to 23.4, 12.9, or 13.3, respectively; a combination of glufosinate ammonium and Shuangzuocaotong in a mixed ratio of 300+15, 300+30 or 450+15 also showed synergistic effect against Capsella bursa-pastoris, wherein the E−E0 values corresponded to 23.8, 14.3, or 12.3, respectively. Among them, the synergistic effect of the combination in the mixed ratio of 300+15 against Descurainia Sophia and Capsella bursa-pastoris was the most obvious, and the E−E0 values were 23.4 and 23.8, respectively. It could be seen that a combination of glufosinate ammonium at a low dose and Shuangzuocaotong at a low dose showed a very good synergistic effect, while a combination of the both at the highest dose for each showed an additive effect. A combination of glufosinate ammonium and Shuangzuocaotong could achieve good control effect at a reduced dose. The synergistic effect of a combination of Shuangzuocaotong and glufosinate ammonium at a ratio of about 1:20-30 was more significant.

### Application Example 2

In order to better understand the present invention, the technical contents of the present invention were specifically described below in conjunction with the examples, and the percentages in the following examples were all mass percentages.

### Example 1: Water Suspension

The compound was Shuangzuocaotong, when the active ingredient B was glyphosate.

The composition formula was: 1% Shuangzuocaotong+30% glyphosate+12% EO-PO block polyether+2% naphthalene sulfonate as a wetting agent+0.2% xanthan gum+5% glycerol+water as balance

The equipments for processing the above water suspension: a mixing tank, a colloid mill, a sand mill, and a shearer etc.

The process for processing the above water suspension: all of the materials were fed into the mixing tank and mixed under stirring, introduced into the colloid mill, then subjected to 3-grade grinding in the sand mill, and finally sheared uniformly in the shearer, and transferred to the storage tank after passing the inspection.

### Example 2: Water Suspension

The compound was Shuangzuocaotong, when the active ingredient B was glufosinate ammonium.

The composition formula was: 2% Shuangzuocaotong+20% glufosinate ammonium+5% phenyethyl phenol polyoxyethylene ether phosphate triethanolamine salt+2% fatty alcohol polyoxyethylene ether+0.15% xanthan gum+5% glycerol+water as balance.

The equipments for processing the above water suspension: a mixing tank, a colloid mill, a sand mill, and a shearer etc.

The process for processing the above water suspension: all of the materials were fed into the mixing tank and mixed under stirring, introduced into the colloid mill, then subjected to 3-grade grinding in the sand mill, and finally sheared uniformly in the shearer, and transferred to the storage tank after passing the inspection.

TABLE 3
Main technical indexes of water suspensions

| | | | | thermal storage | low temperature | fineness |
|---|---|---|---|---|---|---|
| | | persistent | | (54° C.) stability | (0° C.) stability | (passing |
| | | foaming | residue | (decomposition | (volume of | through |
| Technical | suspension | (after one | after | rate of active | isolated | 45 μm |
| indexes | percentage | minute) | dumping | components) | substance) | sieve) |
| Examples 1 | ≥96% | ≤20 ml | ≤3% | ≤3% | ≤0.1 ml | ≥96% |
| and 2 | | | | | | |
| Specification | ≥90% | ≤25 ml | ≤5% | ≤5% | ≤0.3 ml | ≥90% |
| requirements | | | | | | |
| for pesticide | | | | | | |
| products | | | | | | |

### Example 3: Dispersible Oil-Based Suspension

The compound was Shuangzuocaotong, when the active ingredient B was glyphosate.

The composition formula was: 1% Shuangzuocaotong+20% glyphosate+2% calcium dodecylbenzen sulfonate+4% phenyethyl phenol polyoxyethylene ether phosphate triethanolamine salt+5% fatty alcohol polyoxyethylene ether+4% castor oil polyoxyethylene ether+2.2% organobentonite+methyl oleate as balance.

The equipments for processing the above dispersible oil-based suspension: a mixing tank, a colloid mill, a sand mill, and a shearer etc.

The process for processing the above dispersible oil suspension: all of the materials were fed into the mixing tank and mixed under stirring, introduced into the colloid mill, then subjected to 3-grade grinding in the sand mill, and finally sheared uniformly in the shearer, and transferred to the storage tank after passing the inspection.

### Example 4: Dispersible Oil-Based Suspension

The compound was Shuangzuocaotong, when the active ingredient B was glufosinate ammonium.

The composition formula was: 1% Shuangzuocaotong+20% glufosinate ammonium+4% sodium diethylhexyl sulfosuccinate+6% polyoxyethylene nonylphenol ether+7% castor oil polyoxyethylene ether+2% organobentonite+10% soybean oil+methyl oleate as balance.

The equipments for processing the above dispersible oil-based suspension: a mixing tank, a colloid mill, a sand mill, and a shearer etc.

The process for processing the above dispersible oil suspension: all of the materials were fed into the mixing tank and mixed under stirring, introduced into the colloid mill, then subjected to 3-grade grinding in the sand mill, and finally sheared uniformly in the shearer, and transferred to the storage tank after passing the inspection.

TABLE 4
Main technical indexes of dispersible oil-based suspensions

| | | | | | low temperature |
|---|---|---|---|---|---|
| | | | | thermal storage | (0° C.) |
| | | persistent | | (54° C.) stability | stability |
| | | foaming | residue | (decomposition | (volume of |
| Technical | suspension | (after | after | rate of active | isolated |
| indexes | percentage | one minute) | dumping | components) | substance) |
| Examples 3 | ≥95% | ≤20 ml | ≤3% | ≤3% | ≤0.1 ml |
| and 4 | | | | | |
| Specification | ≥80% | ≤25 ml | ≤5% | ≤5% | ≤0.3 ml |
| requirements | | | | | |
| for pesticide | | | | | |
| products | | | | | |

### Example 5: Wettable Powder

The compound was Shuangzuocaotong, when the active ingredient B was glyphosate.

The composition formula was: 2% Shuangzuocaotong+60% glyphosate+10% naphthalene sulfonate as a dispersing agent+5% Nekal+5% precipitated silica+kaolin as balance.

The equipments for processing the above wettable powder: a mechanical mill, and a jet mill.

The process for processing the above wettable powder: the TCs, auxiliaries, fillers etc. were fed into the mechanical mill, then introduced into the jet mill, sampled, and detected, and qualified product was for future use.

### Example 6: Wettable Powder

The compound was Shuangzuocaotong, when the active ingredient B was glufosinate ammonium.

The composition formula was: 3% Shuangzuocaotong+40% glufosinate ammonium+10% sodium lignosulfonate as a dispersing agent+2.5% sodium lauryl sulfate+10% precipitated silica+calcium bentonite as balance.

The equipments for processing the above wettable powder: a mechanical mill, and a jet mill.

The process for processing the above wettable powder: the TCs, auxiliaries, fillers etc. were fed into the mechanical mill, then introduced into the jet mill, sampled, and detected, and qualified product was for future use.

TABLE 5
Main technical indexes of wettable powders

| | | | | | fineness | |
|---|---|---|---|---|---|---|
| | | | | | (passing | |
| Technical | dispers- | suspension | wetting | | through 45 | water |
| indexes | ibility | percentage | time | | μm sieve) | content |
| Examples 5 | ≥90% | ≥90% | ≤90 | s | ≥98% | ≤2% |
| and 6 | | | | | | |
| Specification | ≥80% | ≥60% | ≤120 | s | ≥95% | ≤3% |
| requirements | | | | | | |
| for pesticide | | | | | | |
| products | | | | | | |

### Example 7: Soluble Powder

The compound was Shuangzuocaotong, when the active ingredient B was glyphosate.

The composition formula was: 2% Shuangzuocaotong+60% glyphosate+20% EO-PO block polyether as a dispersing agent+5% Nekal+5% urea+ammonium sulfate as balance.

The equipments for processing the above soluble powder: a mechanical mill, and a jet mill.

The process for processing the above soluble powder: the TCs, auxiliaries, fillers etc. were fed into the mechanical mill, then introduced into the jet mill, sampled, and detected, and qualified product was for future use.

### Example 8: Soluble Powder

The compound was Shuangzuocaotong, when the active ingredient B was glufosinate ammonium.

The composition formula was: 2% Shuangzuocaotong+20% glufosinate ammonium+20% naphthalene sulfonate as a dispersing agent+5% sodium lauryl sulfate+1% precipitated silica+anhydrous sodium sulfate as balance.

The equipments for processing the above soluble powder: a mechanical mill, and a jet mill.

The process for processing the above soluble powder: the TCs, auxiliaries, fillers etc. were fed into the mechanical mill, then introduced into the jet mill, sampled, and detected, and qualified product was for future use.

TABLE 6
Main technical indexes of soluble powders

| | | | | | thermal storage |
|---|---|---|---|---|---|
| | | | | fineness | (50° C.) |
| | | persistent | content of | (passing | stability |
| | | foaming | water- | through | (decomposition |
| Technical | water | (after one | insoluble | 40 μm | rate of active |
| indexes | content | minute) | substances | sieve) | components) |
| Examples 7 | ≤1% | ≤3 ml | ≤1% | ≥99% | ≤3% |
| and 8 | | | | | |
| Specification | ≤1.5% | ≤5 ml | ≤1.5% | ≥97% | ≤5% |
| requirements | | | | | |
| for pesticide | | | | | |
| products | | | | | |

### Example 9: Water Dispersible Granule

The compound was Shuangzuocaotong, when the active ingredient B was glyphosate.

The composition formula was: 2% Shuangzuocaotong+60% glyphosate+10% polycarboxylate as a dispersing agent+5% Nekal+1% polyvinyl alcohol as a disintegrant+diatomite as a filler as balance.

The equipments for processing the above water-dispersible granule: a jet mill, a coulter type mixer, a basket granulator, a drying oven, and a screening device etc.

The process for processing the above water-dispersible granule: the above materials were mixed uniformly, passed through the jet mill, kneaded by adding water and granulized, dried, and screened to obtain the product.

### Example 10: Water Dispersible Granule

The compound was Shuangzuocaotong, when the active ingredient B was glufosinate ammonium.

The composition formula was: 2% Shuangzuocaotong+20% glufosinate ammonium+15% naphthalene sulfonate as a dispersing agent+2.5% sodium dodecyl benzene sulfonate+1% polyethylene glycol-4000 as a disintegrant+kaolin as a filler as balance.

The equipments for processing the above water-dispersible granule: a jet mill, a coulter type mixer, a basket granulator, a drying oven, and a screening device etc.

The process for processing the above water-dispersible granule: the above materials were mixed uniformly, passed through the jet mill, kneaded by adding water and granulized, dried, and screened to obtain the product.

TABLE 7
Main technical indexes of water dispersible granules

| | | | | | fineness | |
|---|---|---|---|---|---|---|
| | | | | | (passing | |
| Technical | dispers- | suspension | wetting | | through 45 | water |
| indexes | ibility | percentage | time | | μm sieve) | content |
| Examples 9 | ≥90% | ≥90% | ≤60 | s | ≥99% | ≤1.5% |
| and 10 | | | | | | |
| Specification | ≥80% | ≥60% | ≤120 | s | ≥95% | ≤3% |
| requirements | | | | | | |
| for pesticide | | | | | | |
| products | | | | | | |

### Example 11: Soluble Granule

The compound was Shuangzuocaotong, when the active ingredient B was glyphosate.

The composition formula was: 2% Shuangzuocaotong+60% glyphosate+12% polycarbonate as a dispersing agent+5% Nekal+1% polyethylene glycol as a disintegrant+urea as a filler as balance.

The equipments for processing the above soluble granule: a jet mill, a coulter type mixer, a basket granulator, a drying oven, and a screening device etc.

The process for processing the above soluble granule: the above materials were mixed uniformly, passed through the jet mill, kneaded by adding water and granulized, dried, and screened to obtain the product.

### Example 12: Soluble Granule

The compound was Shuangzuocaotong, when the active ingredient B was glufosinate ammonium.

The composition formula was: 2% Shuangzuocaotong+40% glufosinate ammonium+15% naphthalene sulfonate as a dispersing agent+2.5% sodium dodecyl benzene sulfonate+1% polyethylene glycol-4000 as a disintegrant+anhydrous sodium sulfate as a filler as balance.

The equipments for processing the above soluble granule: a jet mill, a coulter type mixer, a basket granulator, a drying oven, and a screening device etc.

The process for processing the above soluble granule: the above materials were mixed uniformly, passed through the jet mill, kneaded by adding water and granulized, dried, and screened to obtain the product.

TABLE 8
Main technical indexes of soluble granules

| | | | | | thermal storage |
|---|---|---|---|---|---|
| | | | | fineness | (50° C.) |
| | | persistent | content of | (passing | stability |
| | | foaming | water- | through | (decomposition |
| Technical | water | (after one | insoluble | 40 μm | rate of active |
| indexes | content | minute) | substances | sieve) | components) |
| Examples 11 | ≤1% | ≤3 ml | ≤1% | ≥99% | ≤3% |
| and 12 | | | | | |
| Specification | ≤1.5% | ≤5 ml | ≤1.5% | ≥97% | ≤5% |
| requirements | | | | | |
| for pesticide | | | | | |
| products | | | | | |

### Application Example 3

Tests on herbicidal effect of a compounded composition of glyphosate or glufosinate ammonium with Shuangzuocaotong for controlling weeds in a non-cultivated field

Used formulations: a compounded composition of glyphosate or glufosinate ammonium with Shuangzuocaotong, which was developed and produced by Qingdao Nongguan Pesticide Co., Ltd.

Control formulations: an aqueous formulation of 30% glyphosate; a soluble liquid formulation of 200 g/L glufosinate ammonium (commercially available); an OD of 10% Shuangzuocaotong (Qingdao Nongguan Pesticide Co., Ltd.).

Artificially weeding and treatment with clear water were set as controls.

Usage method: a formulation was diluted with 30 L water per acre and evenly sprayed on each region.

Application time: stage in which weeds grown vigorously, by foliage spraying once.

Investigation Method and Calculation for Control Effect

Weeds to be investigated were: Descurainia Sophia, Capsella bursa-pastoris, Amaranthus retroflexus L. and Portulaca oleracea l., the control effect expressed by fresh weight of weeds of 20 days and 40 days after application was investigated.

The control effect expressed by fresh weight was calculated by the following formula:

$$Control effect expressed by fresh weight ( \% ) = \frac{\begin{matrix}fresh weight of weeds in control region treated \\ with clear water - fresh weight of weeds in region \\ treated with agent ( s )\end{matrix}}{\begin{matrix}fresh weight of weeds in control region treated \\ with clear water\end{matrix}}$$

TABLE 9
Control effect of a compounded composition of glyphosate and Shuangzuocaotong
for controlling weeds in a non-cultivated field

| | | Control effect expressed by fresh | | | Control effect expressed by fresh | | |
|---|---|---|---|---|---|---|---|
| | | weigh of 20 days after application (%) | | | weigh of 40 days after application (%) | | |
| | Dose of | Capsella bursa- | Descurainia | | Capsella bursa- | Descurainia | |
| Formulation | formulation | pastoris | sophia | total | pastoris | sophia | total |
| Example 1 | 200 g/acre | 92.80 | 95.45 | 93.61 | 97.11 | 94.37 | 95.39 |
| Example 3 | 200 g/acre | 96.01 | 93.28 | 95.12 | 94.23 | 95.40 | 95.16 |
| Example 5 | 100 g/acre | 94.56 | 94.09 | 93.30 | 94.67 | 93.72 | 96.64 |
| Example 7 | 100 g/acre | 96.41 | 97.49 | 96.84 | 98.49 | 98.33 | 97.92 |
| Example 9 | 100 g/acre | 95.41 | 94.28 | 94.25 | 96.22 | 94.23 | 95.57 |
| Example 11 | 100 g/acre | 93.32 | 95.40 | 99.48 | 93.24 | 99.47 | 97.00 |
| Aqueous | 200 g/acre | 86.22 | 84.10 | 90.11 | 84.06 | 91.45 | 91.30 |
| formulation of | | | | | | | |
| 30% glyphosate | | | | | | | |
| OD of 10% | 30 g/acre | 85.71 | 83.65 | 68.57 | 88.13 | 88.66 | 70.60 |
| Shuangzuocaotong | | | | | | | |

In Table 9 above, only the specific data for Descurainia sophia and Capsella bursa-pastoristhe was listed in detail, and the total value was a statistical average for Descurainia Sophia, Capsella bursa-pastoris, Amaranthus retroflexus L. and Portulaca oleracea l. It could be seen from Table 9 that a combination of Shuangzuocaotong and glyphosate had good control effect against weeds in a non-cultivated filed, which was better than that of the formulation comprising single agent alone, and was significantly different from that of the control formulations and treatment with clear water as a control, and the combination exhibited better quick-acting effect and lasting validity.

TABLE 10
Control effect of a compounded composition of glufosinate ammonium and
Shuangzuocaotong for controlling weeds in a non-cultivated field

| | | Control effect expressed by fresh | | | Control effect expressed by fresh | | |
|---|---|---|---|---|---|---|---|
| | | weigh of 20 days after application (%) | | | weigh of 40 days after application (%) | | |
| | Dose of | Capsella bursa- | Descurainia | | Capsella bursa- | Descurainia | |
| Formulations | formulation | pastoris | sophia | Total | pastoris | sophia | total |
| Example 2 | 200 g/acre | 92.27 | 94.92 | 93.08 | 96.58 | 93.84 | 93.86 |
| Example 4 | 200 g/acre | 95.48 | 92.75 | 94.59 | 93.70 | 94.87 | 95.63 |
| Example 6 | 100 g/acre | 94.03 | 93.56 | 92.77 | 94.14 | 93.19 | 97.11 |
| Example 8 | 200 g/acre | 95.88 | 96.96 | 96.31 | 97.96 | 97.80 | 97.39 |
| Example 10 | 200 g/acre | 94.88 | 93.75 | 93.72 | 95.69 | 93.70 | 98.04 |
| Example 12 | 100 g/acre | 92.79 | 94.87 | 98.95 | 92.71 | 98.94 | 96.47 |
| soluble liquid | 300 g/acre | 85.69 | 83.57 | 89.58 | 83.53 | 90.92 | 90.77 |
| formulation of | | | | | | | |
| 200 g/L glufosinate | | | | | | | |
| ammonium | | | | | | | |
| OD of 10% | 30 g/acre | 85.18 | 83.12 | 67.04 | 87.60 | 88.13 | 69.06 |
| Shuangzuocaotong | | | | | | | |

In Table 10 above, only the specific data for Descurainia sophia and PP-3 Capsella bursa-pastoristhe was listed in detail, and the total value was a statistical average for Digitaria sanguinalis (l.) scop., Descurainia Sophia, Capsella bursa-pastoris, Amaranthus retroflexus L. and Portulaca oleracea l. It could be seen from Table 10 that a combination of Shuangzuocaotong and glufosinate ammonium had good control effect against weeds in a non-cultivated filed, which was better than that of the formulation comprising single agent alone, and was significantly different from that of control formulations, artificially weeding and treatment with clear water as controls, and the combination exhibited better quick-acting effect and lasting validity.

1. A compounded herbicidal composition comprising an active ingredient A and an active ingredient B, wherein the active ingredient A is Shuangzuocaotong, and the active ingredient B is glyphosate or glufosinate ammonium.

2. The compounded herbicidal composition according to claim 1, wherein the active ingredient A and the active ingredient B are present in a weight ratio of 1:100-1.

3. The compounded herbicidal composition according to claim 2, wherein the active ingredient A and the active ingredient B are present in a weight ratio of 1:60-1.

4. The compounded herbicidal composition according to claim 1, wherein the active ingredients are present in a concentration ranging from 0.001% to 98% by weight.

5. The compounded herbicidal composition according to claim 4, wherein the active ingredients are present in a concentration ranging from 0.01% to 90% by weight.

6. The compounded herbicidal composition according to claim 1, wherein the compounded herbicidal composition further comprises an auxiliary, and wherein said auxiliary is at least one selected from the group consisting of liquid carriers, solid carriers, dispersing agents, emulsifying agents, stabilizing agents, antifreezing agents, and thickening agents.

7. The compounded herbicidal composition according to claim 1, wherein the compounded herbicidal composition is in a dosage form selected from the group consisting of liquids, wettable powders, soluble powders, soluble granules, mulsifiable concentrates, water suspensions, dispersible oil-based suspensions, microcapsules, microemulsions, aqueous emulsions, suspo-emulsions, water dispersible granules, microencapsulated water suspension concentrate, ultra-low volume liquids, and seed coatings.

8. A method for controlling an undesired plant, comprising applying the compounded herbicidal composition according to claim 1 to at least one of a growing place or foliage of the undesired plant.

9. The compounded herbicidal composition according to claim 2, wherein the active ingredients are present in a concentration ranging from 0.001% to 98% by weight.

10. The compounded herbicidal composition according to claim 9, wherein the active ingredients are present in a concentration ranging from 0.01% to 90% by weight.

11. The compounded herbicidal composition according to claim 2, wherein the compounded herbicidal composition further comprises an auxiliary, and said auxiliary is at least one selected from the group consisting of liquid carriers, solid carriers, dispersing agents, emulsifying agents, stabilizing agents, antifreezing agents and thickening agents.

12. The compounded herbicidal composition according to claim 2, wherein the compounded herbicidal composition is in a dosage form selected from the group consisting of liquids, wettable powders, soluble powders, soluble granules, mulsifiable concentrates, water suspensions, dispersible oil-based suspensions, microcapsules, microemulsions, aqueous emulsions, suspo-emulsions, water dispersible granules, microencapsulated water suspension concentrate, ultra-low volume liquids, and seed coatings.
